(19) United States
(12) Patent Application Publication
(10) Pub. No.: US 2025/0142172 A1
(43) Pub. Date: May 1, 2025

(54) METHOD AND SYSTEM FOR ENRICHING AUDIOVISUAL CONTENT

(71) Applicant: SKOLEOM PLATFORM SAS, Palaiseau (FR)

(72) Inventors: Arnaud Gokou, Evry-Courcouronnes (FR); Kevin Racois, Saint Fargeau Ponthierry (FR)

(21) Appl. No.: 18/835,421

(22) PCT Filed: Feb. 2, 2023
(86) PCT No.: PCT/EP2023/052610

§ 371 Date: Aug. 2, 2024

(30) Foreign Application Priority Data
Feb. 4, 2022 (FR) FR2201014

(51) Int. Cl. H04N 21/4725; H04N 21/254; H04N 21/466

(52) U.S. Cl. CPC H04N 21/4725; H04N 21/2542; H04N 21/4665

(57) ABSTRACT

A method for enriching initial video content comprises:—a step of playing the initial video content, which step is designed to recognize predetermined elements therein;—a step of classifying the recognized elements;—a step of searching for and selecting digital resources and/or services associated with the recognized and classified elements;—a step of creating one or more capsules associated with each of the recognized and classified elements intended to contain the selected digital resources and/or services; and—a step of integrating the one or more created capsules into the initial video content so as to deliver enriched video content.

### CROSS-REFERENCE TO RELATED APPLICATIONS

This application is a national phase entry under 35 U.S.C. § 371 of International Patent Application PCT/EP2023/052610, filed Feb. 2, 2023, designating the United States of America and published as International Patent Publication WO 2023/148296 A1 on Aug. 10, 2023, which claims the benefit under Article 8 of the Patent Cooperation Treaty of French Patent Application Serial No. FR2201014, filed Feb. 4, 2022.

### TECHNICAL FIELD

The present disclosure concerns a method for enriching audiovisual content. It also relates to a system implementing this method, in particular, a digital platform.

The field of the present disclosure includes digital communications, digital marketing, video and e-commerce.

### BACKGROUND

Steep growth is currently being observed in audiovisual content offerings. More and more of this audiovisual content is associated with brands and commercial offers.

Today, if someone viewing one such audiovisual content wishes to purchase a product or service seen therein, they must be redirected, via a digital communication network, to a sales site on the Web and use a payment tool. Examples include “Click and Buy®” and “Google Ads®.”

The disadvantage of current methods is that they do not give users real-time access to product or service purchasing services.

Furthermore, it is difficult for video content creators to include in their video content the technical means to provide viewers of their video creations with simple, direct access for purchases or access to services.

One of the main aims of the present disclosure is to remedy this drawback by proposing an innovative video content enhancement method that is powerful and easy to use.

### BRIEF SUMMARY

This objective is achieved with a method for enriching initial video content, comprising the following steps:
playing this initial video content, designed to recognize predetermined elements therein,
classifying the elements thus recognized,
searching for and selecting digital resources and/or services associated with the recognized and classified elements,
creating one or more capsules associated with each recognized and classified element, intended to contain the selected digital resources and/or services, and
integrating the capsule(s) thus created into the original video content, so as to deliver enriched video content.

The steps of recognizing and classifying can advantageously implement artificial intelligence techniques.

The step of integrating into the initial video content can be arranged to graphically represent a capsule when viewing the enriched video content.

The enrichment method according to the present disclosure may also comprise a step for creating tactile selection zones in the enriched video content, associated with one or more selected elements to which one or more capsules have been associated, so that a tactile action on one of these selection zones causes a capsule associated with it to be displayed.

The capsule creation step can be arranged to include in this capsule an additional video and/or an online store and/or a searchable document such as a press article.

### BRIEF DESCRIPTION OF THE DRAWINGS

Embodiments of the present disclosure will be better understood in view of the figures, in which:

FIG. 1 is a block diagram of one embodiment of the method for enriching video content according to the present disclosure;

FIG. 2 is an example of a block diagram of a prediction and identification algorithm implemented in the method for enriching video content according to the present disclosure;

FIG. 3 shows the first four steps of an example of the enrichment method according to the present disclosure; and

FIG. 4 shows three further steps in the exemplary embodiment shown in FIG. 1.

### DETAILED DESCRIPTION

### Definitions

iFrame: name given to an HTML tag used in computer language to integrate the content of another HTML page into an HTML page.

API: for Application Programming Interface: application programming interface comprising a set of definitions and protocols that facilitate the creation and integration of application software.

Bounding Box: A rectangle aligned with the axis. This is the simplest type of closed planar shape, represented by two points containing the minimum and maximum coordinates of each axis.

PyTorch: An open-source machine learning framework that accelerates the transition from research prototyping to production deployment.

SAAS: for Software as a Service: an application software solution hosted in the cloud and operated outside the organization or company by a third party, also known as a service provider. The SaaS solution is accessible on demand via an Internet connection.

Confidence score: Classification confidence scores are designed to measure the accuracy of the model when predicting class assignment.

YOLOv5: A family of compound-scaled object detection models, trained on the COCO dataset, with simple features for increasing test time (TTA), model assembly, hyperparameter evolution and export to ONNX, CoreML and TFLite.

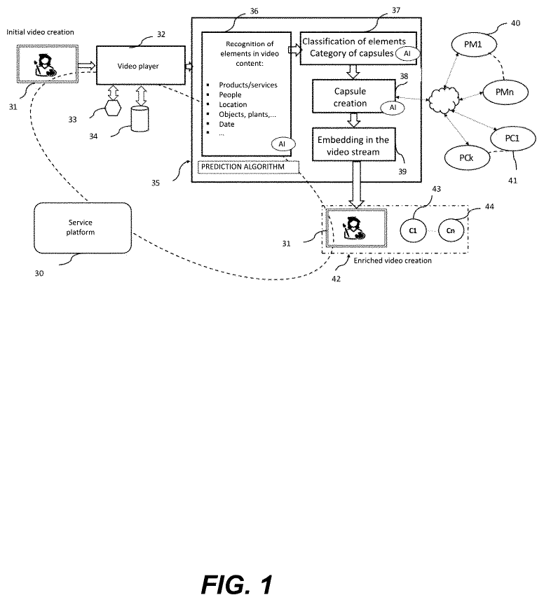

With reference to FIG. 1, the enrichment method according to the present disclosure can be implemented on a service platform 30 intended for video content creators and available in the form of a SAAS application. On this platform 30, a video content creator can input initial video content 31. A video player 32 is equipped with an identification/authentication device 33 and linked to a database 34. This video player implements a set of artificial intelligence algorithms 35 that will perform the following operations:
a series 36 of recognitions of elements in the initial video content 31, such as products and/or services, people, places, objects, plants or animals, dates and many other elements, using known artificial intelligence (AI) techniques,
a classification 37 of these recognized elements using known learning techniques and with reference to predetermined capsule categories,
a creation 38 of capsules associated with each element recognized and selected by the user of the method of the platform 30, and
an insertion 39 of these capsules into the initial video stream, so as to deliver enriched video content 42 from the initial video content 31, now incorporating 43, 44 several capsules C1, . . . , Cn.

Capsule content created in this way is retrieved by accessing, for example, in the Cloud (digital cloud) or via digital networks or the Web, marketplaces PM1, . . . Pmn as well as content platforms, notably video content platforms, PC1, . . . PCk 41.

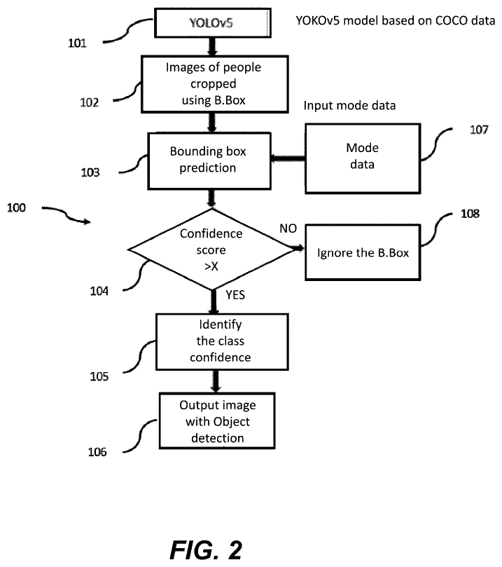

With reference to FIG. 2, an example of an artificial intelligence algorithm implemented to detect elements (people) in video content will now be described.

This algorithm 100 was created using the Py Torch coding tool commonly used in machine learning. In a first step 101, a YOLOv5 compound-scaled object detection model is implemented on COCO data. From this model, cropped person images using bounding boxes 102 (or B.Boxes) are identified. The next step 103 is a bounding box prediction from mode data 107.

The prediction is then subjected to a confidence score test, a well-known technique in machine learning, in step 104. If the confidence score is less than a predetermined value X, then this bounding box B.Box is ignored (step 108). If, on the other hand, the confidence score is greater than X, then the next step is 105 to identify the class confidence, followed by the step 106 to detect the image containing the desired object.

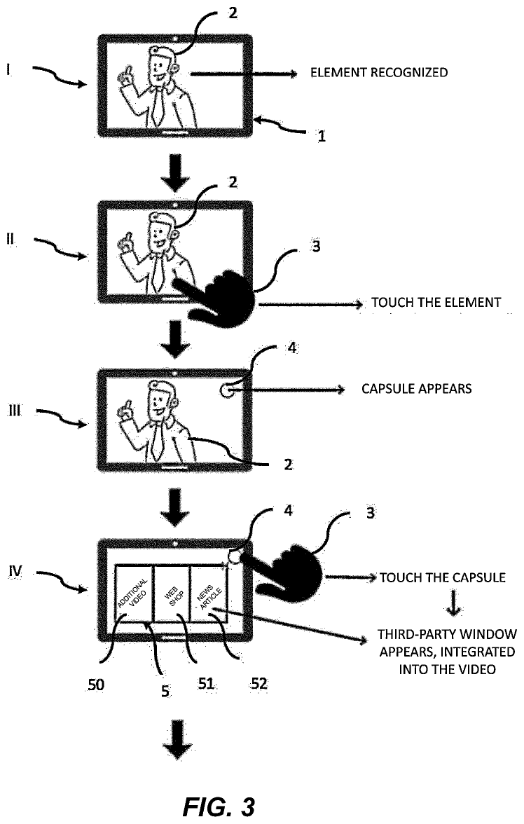

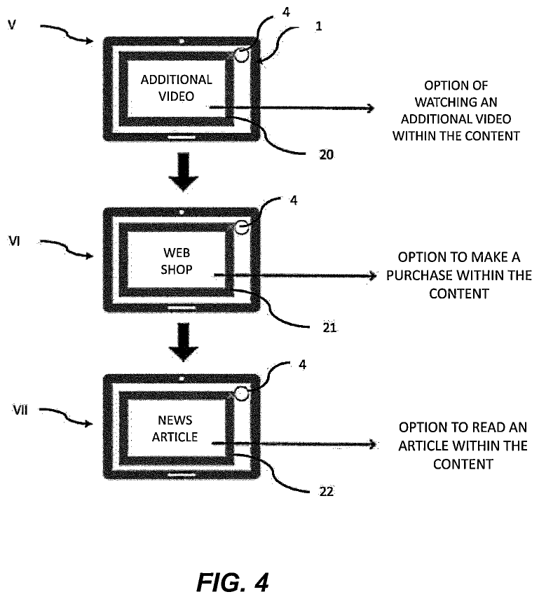

With reference to FIGS. 3 and 4, an example of the use of enriched video content by a person viewing or consulting this content on electronic communication equipment 1, such as a smartphone, tablet or personal computer, will now be described.

In a first step I, the person consults the video content and locates an element, such as a known actor 2. In a second step II, the person then selects this element 2 by touching the screen 1 with a finger of their hand 3.

In a third step III, this selection causes a capsule icon 4 to be displayed in a corner of the screen 1, for example, the top right-hand corner.

The person then selects (step IV) this capsule icon 4, which causes a window 5 to appear on screen 1, integrated into the video, this window 5 comprising three zones 50, 51, 52 corresponding respectively to an additional video, an online store and a press article, these three resources all being related to the selected element 2.

So, if the user selects (step V) the zone 50, a window 20 for viewing an additional video appears and the user can directly watch this additional video within the enriched video content.

If the user selects the zone 51 (step VI), an online store 21 appears, integrated within the enriched video content.

If the user selects (step VII) the zone 52, a window 22 for reading a news article appears, integrated within the enriched video content.

The method for producing enriched audiovisual content can be implemented on a video creation platform. This method enables video content creators to offer their viewers the opportunity to interact within their creation.

The video player can be available as a SAAS application for technology novices and video professionals alike, and allows for the embedding of brands that a creator would like to see integrated into your audiovisual content.

The video player used in the method according to the present disclosure may have the following features:
product/service recognition: Artificial intelligence can recognize products and services embedded in the video,
people recognition: Artificial intelligence can recognize all the people in the video content,
location recognition: Artificial intelligence can recognize most similar locations in the video and give a precise address in the form of a geolocation (GPS),
object, plant and animal recognition: Artificial intelligence can recognize most types of objects, plants and animals in the video,
date recognition: Artificial intelligence can recognize a specific date (most),
analysis of the clothes worn by the protagonists, types of objects, etc., and
food and beverage recognition: Artificial intelligence can recognize a dish and its ingredients, and extract the ingredients of the dish.

### Classification of Elements and Capsules

The enrichment method is designed to classify the capsules created as a result of the recognition process. Artificial intelligence will classify all recognized elements in a capsule integrated into the top right-hand corner of a video.

It will then deduce three offers for the element:
an additional video: This video is extracted from the YouTube catalog or other videos from a public API, the closest one to the product for sale being integrated into the capsule. This additional content can be a report, a promotional video or a tutorial video;
an offer to buy a product or service: this product or service can be sourced from millions of products available on partners' international marketplaces; and
an article: an article describing the product is automatically generated by artificial intelligence from information available on websites.

The texts describing these offers can be translated into several languages simultaneously.

### Database

For product recognition, artificial intelligence selects products available on e-commerce platforms worldwide. If the products are not recognized on one of the platforms, the artificial intelligence then sends a “product to be created” message to the product creation department, which will create the product in question: dimensions, colors, materials, etc.

The artificial intelligence is designed to perform the following operations:
“cut out” the product from the video content to extract a photo and put it on a white background, extract a 3D video rotating on a white background,
assign it a sales price after benchmarking similar products internationally, automatically launch the product's production machine in a production plant,
reference the inventory available in the video content, and
publish the product in online video stores and make it available to the public.

The user of the communication equipment can touch the screen at any time. This action causes a capsule to appear on the screen. Beforehand, the user will have validated the conditions of use of the product prediction algorithm.

The video player can be equipped with a biometric fingerprint reader, and offer the customer the option of registering data such as banking information, tastes, height, weight, measurements, identity, address, function, etc.

As soon as the customer validates the element on their screen with their finger, the ordered product is sent directly to their home.

### EXAMPLES OF CAPSULES

Numerous types of capsule can be envisaged. The following is a non-exhaustive list of capsules that can be created as a result of the method for recognition in video content.
1. PEOPLE
2. LOCATION
3. EVENT
4. OBJECTS
5. PLANTS
6. ANIMALS
7. COSMETICS
8. GAMES
9. SPIRITUALITY & RELIGION
10. PERSONAL DEVELOPMENT
11. DATE
12. FOOD AND BEVERAGES
13. CLOTHING AND ACCESSORIES
14. CARS AND ACCESSORIES
15. FURNITURE
16. CONTESTS
17. REAL ESTATE
18. BEAUTY
19. TRAVEL
20. VOTING
21. MUSIC
22. ANIMATION
23. CHILDREN
24. TECH
25. BOOKS
26. BANKING
27. SCIENCE
28. EDUCATION
29. TRAINING
30. METHODS
31. GOVERNMENT

As a non-limiting example, 200 capsules for a 3-minute video, 600 capsules for a 6-minute video and over 1000 capsules for a video longer than 6 minutes may be contemplated.

The user of the enrichment method according to the present disclosure integrates video content in the form of a file or link into the Web platform or SAAS application.

The artificial intelligence then processes the video content over a period of time equal to or less than the duration of the video content, depending on the availability of the queue for this process, referencing all the information in a dashboard assigned to the user.

The platform for implementing the enrichment method according to the present disclosure can be designed to group together a plurality of services made available to creators and referred to under the term “Transmedia Universe”:
1. Watch a video
2. Create an account
3. Download a video
4. Forward from social media account
5. Call (like WhatsApp®)
6. Chat (like Facebook®)
7. Buy products and services (like Amazon®)
8. Monetize video content (like Youtube®)
9. Conference calls (like Zoom®)
10. PAY (like Apple Pay®)
11. BANK (like N26®)
12. REAL ESTATE (like a real estate agency)
13. PRODUCTION (like Netflix®)
14. ENGINE (like Google®)
15. ACADEMIA (like a school that offers courses)
16. VOTING (such as by text)
17. EVENTS (such as Live Nation®)
18. PRODUCTS (like Nike®)
19. GAMES (like Ubisoft®)
20. And many more features and services to be added later . . . .
   1. Video watching: Each user can watch any video on the platform (music, film, documentary, etc.).
   2. Account creation: The user will have an account that will enable them to manage all their operations as on each social network (Facebook, Instagram, Twitter).
   3. Upload: Users can upload their own videos and photos.
   4. Forward from social media account: the enrichment method allows users of any social network to register by creating an account. It also allows users to simply migrate their account, that is to say sign up with their Facebook® or Instagram® or other account directly.
   5. Call (like WhatsApp®): Audio and video calls are possible using the method just like on WhatsApp.
   6. Chat (like Facebook®): The method features a messenger that lets you chat with your contacts like Facebook®.
   7. Purchasing products and services (like Amazon®): The act of purchasing is made possible by simply clicking on the product selected on the screen.
   8. Monetizing video content (like YouTube®): Every content owner has the opportunity to earn money by publishing videos whenever people buy their products. All sales information is recorded directly and in detail in their account.
   9. Conference calls (like Zoom®)
   10. PAY (like Apple Pay®): Users can pay for their purchases with this payment application.
   11. BANK (like N26®): Users can open a bank account and receive a bank statement like any other online bank.
   12. REAL ESTATE: A specialized service enables users to sell or buy their property as in a real estate agency.
   13. PRODUCTION (like Netflix®): The method allows you to produce your own videos, series and films, or any other program intended for direct distribution on the platform.
   14. ENGINE (like Google®): The method develops its own search engine, enabling certain options that others don't offer. For example, the “Search Bar” option enables you to copy a link from a video to extract all the products and offer them for purchase, subject to authorization from the video content owner to access this content.
   15. ACADEMIA (like school classes): This option can be developed for all online courses. In this period of COVID-19, teaching is carried out remotely, enabling the student/teacher relationship to be maintained.
   16. VOTING (such as by SMS): Voting enables the free exchange of messages within a community, as well as voting for competitions, TV shows and more.
   17. EVENTS (like Live Nation®): Live and streaming concerts are possible on the Platform.
   18. PRODUCTS (like Nike®): Designing and manufacturing various products from different sectors. This enables the platform to significantly increase its margins.
   19. GAMES (like Ubisoft®): Online games for people playing on their smartphones and computers.
   20. And many more features and services to be added in the future.

Thanks to partnerships with e-commerce, fashion, real estate and other industries, it is possible to promise customers a wide range of products. As for video creators, they now have the opportunity to create short, interesting videos about the brands listed.

The use of artificial intelligence contributes to revenue optimization and increased visibility for brands and designers.

If video recognition is successful, a predicted number of capsules will appear in the capsule bar on the right-hand side of your screen. This capsule bar remains frozen for the duration of viewing. You can touch the screen at any time. This action opens the Capsule functions.

If video recognition is not enabled, capsules are not automatically displayed on screen. The capsule bar is therefore deactivated. However, you can touch the screen at any time. This action brings up the Capsule bar, which becomes active on the screen. You can interact with the Capsule, which animates three options.

The artificial intelligence implemented in the enrichment method according to the present disclosure is designed to:
recognize all the elements that make up the video.
classify them by capsule under category-based references.
determine whether the capsules are generated by a prospect, customer or advertiser.

Two bars can be displayed below the video:
a “Similar products” bar: products/services have been recognized by the video, but are not identified for a Customer or Advertiser.
a “Specific products” bar: the products/services have been recognized by the video and are identified as those of the Customer or Advertiser.

### Search Bar

A search bar is also offered to the user of the enrichment method according to the present disclosure, to enable them to optimize the relevance of the image or video content that will be associated with the product or service for which it is desired to encourage purchases or user engagement.

An analytics API is provided to perform a search function, which improves the visibility of queries and determines the keywords for displaying the relevant video or images from the Internet.

It also involves defining query rules for problematic queries, or adjusting search attributes/parameters to solve relevant and systemic problems.

Filters are also provided to establish optimized conversion paths by predefining filters on specific keywords based on the most popular filters for video or image searches.

An API from an online store, video or website (photo, video, text) can be stored in the algorithm.

A link is established between the registered API element and the element duplicated in the algorithm.

The element duplicated by Artificial Intelligence is searched for in its database.

When an e-commerce platform makes available products or services, the iFrames of which cannot be directly integrated within video content, it is possible to integrate the products or services with this type of iFrame in a dedicated store to enable the iFrame to be played in full, without leaving the video (otherwise this could be considered click and buy).

It should be noted that the data integrated and therefore duplicated in the algorithm (e.g., over 500 million products—images, texts, videos) can require huge servers and enormous computing times (recognition, linking, recording). An algorithm can then be devised to link the video's publication date with a product's market release date. This has the effect of removing the quantities of searches by the algorithm for products hosted by eCommerce platforms.

Of course, the present disclosure is not limited to the examples that have just been described, and many other embodiments may be envisaged without departing from the scope of this invention. In particular, the number of recognizable elements and capsules that can be integrated into enriched video content is only limited by the capacity and power of the computer servers used.

1. A method for enriching initial video content, comprising the following steps:
playing the initial video content and recognizing predetermined elements in the initial video content;
classifying the recognized predetermined elements;
searching for and selecting digital resources and/or services associated with the recognized and classified predetermined elements;
creating one or more capsules associated with each recognized and classified predetermined element, the capsules containing the selected digital resources and/or services; and
integrating the created one or more capsules into the initial video content to form enriched video content for transmission via a communication network to electronic communication equipment equipped with a touch screen; and
wherein the enriched video content displays, in response to a selection of an element being viewed on the touch screen, a capsule icon, selection of the icon providing access to the content of the capsule.

2. The method of claim 1, wherein each of recognizing the predetermined elements and the classifying of the recognized predetermined elements implement artificial intelligence.

3. The method of claim 2, further comprising creating tactile selection zones in the enriched video content, each tactile selection zone being associated with one or more selected elements to which one or more capsules have been associated, so that a tactile action on one of the tactile selection zones causes a capsule associated with the one of the tactile selection zones to be displayed.

4. The method of claim 3, wherein creating the one or more capsules comprises including an additional video in the one or more capsules.

5. The method of claim 4, wherein creating the one or more capsules comprises including an online store in the one or more capsules.

6. The method of claim 5, wherein creating the one or more capsules comprises including a viewable document in the one or more capsules.

7. A service platform for video content creators, implementing the method according to claim 1, the service platform comprising a video player equipped with an identification/authentication device and connected to a database, the video player implementing a set of artificial intelligence algorithms designed to recognize elements in an initial video content, classify the elements thus recognized and create capsules associated with each recognized element and designed to be inserted into the initial video content.

8. The service platform according to claim 7, wherein the content of the capsules thus created are retrieved by accessing a Cloud or, via digital networks or the Web, marketplaces as well as content platforms.

9. The service platform of claim 8, wherein the service platform is a service as a software application.

10. The method of claim 1, wherein creating the one or more capsules comprises including an additional video in the one or more capsules.

11. The method of claim 1, wherein creating the one or more capsules comprises including an online store in the one or more capsules.

12. The method of claim 1, wherein creating the one or more capsules comprises including a viewable document in the one or more capsules.
